(19) United States
(12) Patent Application Publication
(10) Pub. No.: US 2006/0042856 A1
(43) Pub. Date: Mar. 2, 2006

(54) Apparatus for supporting muffler

(76) Inventors: Hyeon Seok Kim, Suwon-city (KR); Hak Son Han, Hwaseong-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/214,552

(22) Filed: Aug. 30, 2005

(30) Foreign Application Priority Data
Aug. 30, 2004 (KR) 10-2004-0068343

(51) Int. Cl. B60K 13/04

(52) U.S. Cl. 180/296

(57) ABSTRACT

An apparatus supports a muffler whereby vibration noise generated in the muffler is reduced during driving of the vehicle because the strength of the apparatus for supporting the muffler is enhanced.

### CROSS-REFERENCE TO RELATED APPLICATION

This application claims priority to and the benefit of Korean Patent Application 10-2004-0068343 filed in the Korean Intellectual Property Office on Aug. 30, 2004, the entire content of which is incorporated by reference herein.

### TECHNICAL FIELD OF THE INVENTION

The present invention relates to an apparatus for supporting a muffler. More particularly, the present invention relates to an apparatus for supporting a muffler for reducing noise occurring in the muffler during driving of a vehicle.

### BACKGROUND OF THE INVENTION

Generally, a muffler of a vehicle is mounted to a rear portion of a vehicle for reducing noise caused by exhaust gas exiting the engine of the vehicle. The muffler is mounted to the vehicle's body by a hanger that is typically made of elastic material. The elastic material reduces transmission of vibrations between the vehicle body and the muffler.

Conventionally, a muffler is mounted with a hanger rod that is connected to a hanger. The hanger rod is welded to the muffler and a hanger supporter is disposed in a direction corresponding to a direction of the hanger rod. A predetermined distance is maintained between the hanger support and the hanger rod. The hanger support and the hanger rod are respectively inserted to mounting holes of the hanger.

Due to the conventional configuration, the upper mounting hole and the lower mounting hole are formed in the middle of the hanger for inserting one end of each of the hanger support and the hanger rod thereinto. Therefore, a vibration transmitted from an exhaust system to a vehicle body can be reduced.

However, a drawback of the conventional design is that the strength of the hanger rod is insufficient because the hanger rod is welded to only one side of the muffler. In addition, noise caused by vibration of the apparatus for supporting the muffler occurs in a case that an engine operates in high speed or the vehicle is driven at high speed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention includes an apparatus for supporting a muffler having advantages of reducing noise occurring in the muffler during driving by enhancing the strength of the apparatus for supporting the muffler. An exemplary apparatus for supporting the muffler according to an embodiment of the present invention includes an end plate secured to one end of the muffler, a rod having one end secured to the end plate such that the muffler is hung to a vehicle body, and a bracket connected respectively to the rod and the end plate such that the bracket supports the rod with respect to the end plate. An exhaust pipe is connected to the end plate and the bracket is connected to both the exhaust pipe and the end plate. A penetration hole is formed in the bracket and the rod is connected to the bracket by being inserted into the penetration hole.

According to another embodiment for supporting a muffler an apparatus includes an end plate secured to one end of the muffler, a first bracket and a second bracket secured to the end plate, and a rod respectively connected to the first bracket and the second bracket such that the muffler is hung to a vehicle body. First and second penetration holes are respectively formed in the first and second brackets and the rod is connected to the first and second brackets by being inserted into the first and second penetration holes.

### BRIEF DESCRIPTION OF THE DRAWINGS

FIG. 1 shows an apparatus for supporting a muffler according to an embodiment of the present invention;

FIG. 2 shows an apparatus for supporting a muffler according to another embodiment of the present invention; and

FIG. 3 is a perspective view showing an apparatus for supporting a muffler according to yet another embodiment of the present invention.

### DETAILED DESCRIPTION OF THE EMBODIMENTS

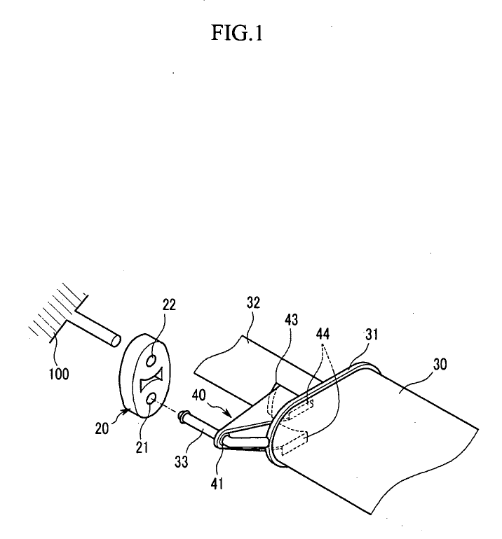

Referring to FIG. 1, an apparatus for supporting a muffler according to an embodiment of the present invention includes an end plate 31, a rod 33, and a bracket 40. The end plate 31 is secured to an end of the muffler 30, and one end of the rod 33 is secured to the end plate 31 such that the muffler 30 is hung to a vehicle body 100.

The bracket 40 is respectively connected to the rod 33 and the end plate 31 such that the bracket 40 supports the rod 33 with respect to the end plate 31. An exhaust pipe 32 for exhausting exhaust gas is connected to the muffler 30 by the end plate 31. The other end of the rod 33 is connected to a hanger 20 which is connected to the vehicle body 100. That is, the muffler 30 can be hung to the vehicle body 100 by the rod 33 being connected to a first mounting hole 21 of the hanger 20 and the vehicle body 100 being connected to a second mounting hole 22.

The exhaust pipe 32 is connected to the end plate 31, and the bracket 40 is connected to both the exhaust pipe 32 and the end plate 31. That is, the first connecting surface 44 of the bracket 40 are connected to the end plate 31 and a second connecting surface 43 is connected to the exhaust pipe 32. According to an embodiment of the present invention, the bracket 40 may be connected to the exhaust pipe 32 and end plate 31 by welding, or the like. A penetration hole 41 is formed in the bracket 40 and the rod 33 is connected to the bracket 40 by being inserted into the penetration hole 41.

Referring to FIG. 1, the portion of the rod 33 that is inserted into the penetration hole 41 has a predetermined angle and the predetermined angle may be changed according to a size of the bracket 40. In addition, because the rod 33 is connected to both the bracket 40 and the end plate 31, the strength of the apparatus for supporting the muffler is sufficient to support the weight of the muffler. Further, transmission of vibrations from the muffler 30 to the vehicle can be reduced through this enhanced muffler coupling.

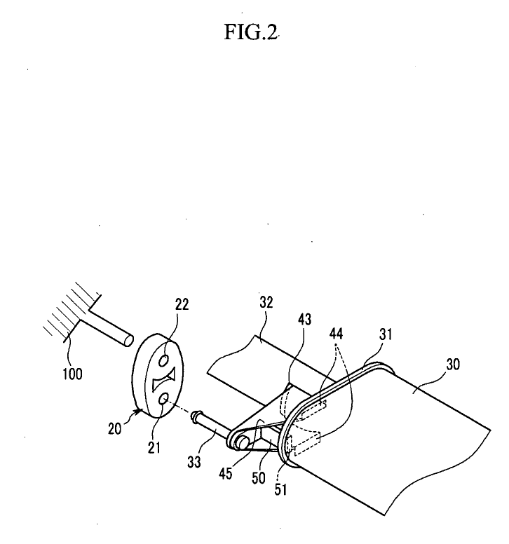

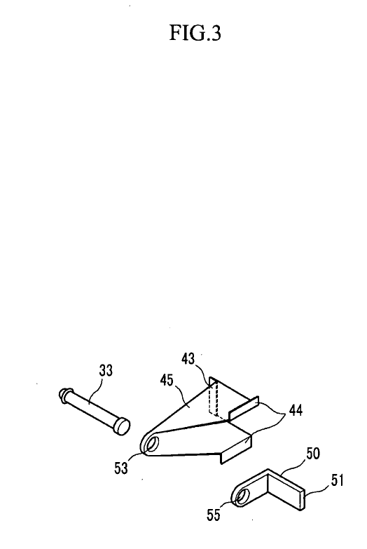

Referring now to FIGS. 2 and 3, another embodiment includes an apparatus for supporting a muffler that includes not only an end plate 31 and a rod 33 but also a first bracket 45 and a second bracket 50. The first bracket 45 and the second bracket 50 are secured to the end plate 31. More particularly, a first connecting surface 44 of the first bracket 45 are connected to the end plate 31 and a second connecting surface 43 is connected to the exhaust pipe 32.

In addition, a third connecting surface 51 of the second bracket 50 is connected to the end plate 31 and a surface of the second bracket 50 that is disposed opposite to the first connecting surfaces 44 of the first bracket 45 is connected to the first bracket 45. The rod 33 is respectively connected to the first bracket 45 and the second bracket 50 such that the muffler 30 is hung to the vehicle body 100.

According to an embodiment of the present invention, the connections among the end plate 31, the exhaust pipe 32, the first bracket 45, and the second bracket 50 may be realized by welding, a bolt, or the like.

Referring to FIG. 3, first and second penetration holes 53 and 55 are respectively formed to the first and second brackets 45 and 50. The rod 33 is connected to the first and second brackets 45 and 50 by being inserted into the first and second penetration holes 53 and 55, respectively.

According to an embodiment of the present invention described above, the strength of the apparatus for supporting the muffler is enhanced because the first and the second brackets 45 and 50 are connected to the end plate 31 connected to the muffler 30. Therefore, the occurrence of noise in the apparatus for supporting the muffler is reduced.

As described above, according to embodiments of the present invention, because the strength of the apparatus for supporting the muffler is enhanced, vibration and noise caused by the vibration can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for supporting a muffler comprising:
an end plate secured to one end of a muffler;
a rod, wherein one end of the rod is secured to the end plate such that the muffler is hung to a vehicle body; and
a bracket respectively connected to the rod and the end plate such that the bracket supports the rod with respect to the end plate.

2. The apparatus of claim 1, wherein:
an exhaust pipe is connected to the end plate; and
the bracket is connected to the exhaust pipe and the end plate together.

3. The apparatus of claim 1, wherein:
a penetration hole is formed in the bracket; and
the rod is connected to the bracket by being inserted into the penetration hole.

4. An apparatus for supporting a muffler comprising:
an end plate secured to one end of the muffler;
a first bracket and a second bracket secured to the end plate; and
a rod respectively connected to the first bracket and the second bracket such that the muffler is hung to a vehicle body.

5. The apparatus of claim 4, wherein:
first and second penetration holes are respectively formed in the first and second brackets; and
the rod is connected to the first and second brackets by being inserted into the first and second penetration holes.
